(19) United States
(12) Patent Application Publication
(10) Pub. No.: US 2025/0356537 A1
(43) Pub. Date: Nov. 20, 2025

(54) METHOD AND APPARATUS FOR GENERATING IMAGE FRAME USING MOTION VECTOR

(71) Applicant: SAMSUNG ELECTRONICS CO., LTD., Suwon-si (KR)

(72) Inventors: Inwoo HA, Suwon-si (KR); Young Chun AHN, Suwon-si (KR); Nahyup KANG, Suwon-si (KR)

(73) Assignee: SAMSUNG ELECTRONICS CO., LTD., Suwon-si (KR)

(21) Appl. No.: 19/064,152

(22) Filed: Feb. 26, 2025

(30) Foreign Application Priority Data
May 14, 2024 (KR) 10-2024-0063364
Sep. 6, 2024 (KR) 10-2024-0121827

(51) Int. Cl. G06T 11/00; G06N 3/0455

(52) U.S. Cl. CPC G06T 11/00; G06N 3/0455

(57) ABSTRACT

Provided is a method and apparatus for generating an image frame using a motion vector. The method includes performing a first encoding operation based on a first image frame at a first time point and a second image frame at a second time point to generate a first encoding feature, performing a first decoding operation based on the first encoding feature to generate a first optical flow feature between the first time point and a third time point and a second optical flow feature between the second time point and the third time point, and generating a third image frame at the third time point based on the first optical flow feature, the second optical flow feature, and a motion vector corresponding to motion between the first image frame and the second image frame.

### CROSS-REFERENCE TO RELATED APPLICATION

This application is based on and claims priority from Korean Patent Application No. 10-2024-0063364, filed on May 14, 2024, and Korean Patent Application No. 10-2024-0121827, filed on Sep. 6, 2024, in the Korean Intellectual Property Office, the entire disclosure of which is incorporated herein by reference for all purposes.

### BACKGROUND

### 1. Field

The disclosure relates to a method and apparatus for generating an image frame using a motion vector.

### 2. Description of Related Art

A neural network may be trained based on deep learning, and used to perform inference for a desired purpose by mapping input data and output data that are in a nonlinear relationship to each other. A trained ability to generate such mapping may be referred to as a learning ability of the neural network. The neural network may be used variously in technical fields related to image enhancement. Recently, frame-generating techniques for frame interpolation have been introduced. For example, by inserting additional frames between original frames, a frame rate may be increased. The neural network may be used to generate the additional frames.

### SUMMARY

According to an aspect of the disclosure, there is provided a method including performing a first encoding operation based on a first image frame at a first time point and a second image frame at a second time point to generate a first encoding feature; performing a first decoding operation based on the first encoding feature to generate a first optical flow feature between the first time point and a third time point and a second optical flow feature between the second time point and the third time point; and generating a third image frame at the third time point based on the first optical flow feature, the second optical flow feature, and a motion vector corresponding to motion between the first image frame and the second image frame.

According to another aspect of the disclosure, there is provided an electronic device including: one or more processors; and a memory configured to store instructions, wherein the instructions, when executed by the one or more processors, cause the electronic device to: perform a first encoding operation based on a first image frame at a first time point and a second image frame at a second time point to generate a first encoding feature; perform a first decoding operation based on the first encoding feature to generate a first optical flow feature between the first time point and a third time point and a second optical flow feature between the second time point and the third time point; and generate a third image frame at the third time point based on the first optical flow feature, the second optical flow feature, and a motion vector corresponding to motion between the first image frame and the second image frame.

According to another aspect of the disclosure, there is provided an electronic device including: a memory configured to store instructions, and one or more processors configured to execute the instructions, the instructions when executed by the one or more processors, cause the electronic device to: perform a first encoding operation based on a first image frame at a first time point and a second image frame at a second time point to generate a first encoding feature; perform a first decoding operation based on the first encoding feature to generate a first optical flow feature between the first time point and a third time point and a second optical flow feature between the second time point and the third time point; perform a second encoding operation based on a motion vector based on the first image and the second image to generate a second encoding feature; perform a second decoding operation based on the second encoding feature to generate a first motion feature between the first time point and the third time point and a second motion feature between the second time point and the third time point; and generate a third image frame at the third time point based on the first optical flow feature, the second optical flow feature, the first motion feature and the second motion feature.

Additional aspects of embodiments will be set forth in part in the description which follows and, in part, will be apparent from the description, or may be learned by practice of the disclosure.

### BRIEF DESCRIPTION OF DRAWINGS

The above and/or other aspects will be more apparent by describing certain embodiments with reference to the accompanying drawings, in which:

FIGS. 1A and 1B are diagrams illustrating examples of a frame generation model according to an embodiment;

FIG. 2 is a diagram illustrating an example of a first time point, a second time point, and a target time point according to an embodiment;

FIG. 3 is a diagram illustrating an example of input data for each of a motion-based model and an image-based model according to an embodiment;

FIG. 4 is a diagram illustrating an example of a configuration of a motion-based model according to an embodiment;

FIG. 5 is a diagram illustrating an example of a configuration of a motion-based encoding model according to an embodiment;

FIG. 6 is a diagram illustrating an example of a configuration of an image-based model according to an embodiment;

FIG. 7 is a flowchart illustrating an example of a method of generating an image frame according to an embodiment; and

FIG. 8 is a diagram exemplarily illustrating a configuration of an electronic device, according to an embodiment.

### DETAILED DESCRIPTION

The following detailed structural or functional description of embodiments is provided as an example only and various alterations and modifications may be made to the embodiments. Here, the embodiments are not construed as limited to the disclosure and should be understood to include all changes, equivalents, and replacements within the idea and the technical scope of the disclosure.

Although terms, such as first, second, and the like are used to describe various components, the components are not limited to the terms. These terms should be used only to distinguish one component from another component. For example, a first component may be referred to as a second component, and similarly the second component may also be referred to as the first component.

It should be noted that when a component or element is described as being “connected to”, “coupled to”, or “joined to” another component or element, it may be directly (e.g., in contact with the other component or element) “connected to”, “coupled to”, or “joined to” the other component or element, or there may reasonably be one or more other components or elements intervening therebetween.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, numbers, operations, members, elements, and/or combinations thereof, but do not preclude the presence or addition of one or more other features, numbers, operations, members, elements, and/or combinations thereof.

As used herein, such phrases as “at least one of A or B” and “at least one of A, B, or C” may include any one of, or all possible combinations of the items enumerated together in a corresponding one of the phrases.

Unless otherwise defined, all terms, including technical and scientific terms, used herein have the same meaning as commonly understood by one of ordinary skill in the art to which the present disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, the embodiments will be described in detail with reference to the accompanying drawings. When describing the embodiments with reference to the accompanying drawings, like reference numerals refer to like components and a repeated description related thereto will be omitted.

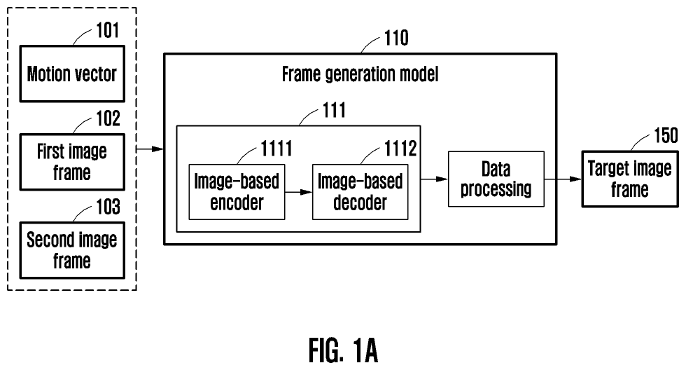

FIGS. 1A and 1B are diagrams illustrating examples of a frame generation model according to an embodiment. Referring to FIG. 1A, a frame generation model 110 may generate a target image frame 150 based on a motion vector 101, a first image frame 102, and a second image frame 103. The first image frame 102 and the second image frame 103 may be successive image frames of a plurality of image frames of a video. The first image frame 102 may correspond to a first time point, and the second image frame 103 may correspond to a second time point. For example, the first image frame 102 may be a frame at the first time point in the video, and the second image frame 103 may be a frame at the second time point in the video. The first time point and the second time point may be successive time points. The target image frame 150 may be inserted between original image frames, such as the first image frame 102 and the second image frame 103, and may have an increased frame rate. The insertion of the target image frame 150 may be referred to as frame interpolation.

The motion vector 101 may correspond to motion between the first image frame 102 and the second image frame 103. The motion vector 101 may include information of vectors representing the corresponding motion. A video including the first image frame 102 and the second image frame 103 may be a computer graphics video. The computer graphics video may include, but is not limited toe, video games, movies, animations, virtual reality (VR) images, augmented reality (AR) images, and the like. The computer graphics video may be generated by a rendering engine. The rendering engine may be implemented as one or more hardware modules and/or one or more software modules.

The rendering engine may generate each image frame of the computer graphics video based on a rendering pipeline. The rendering pipeline may allow three-dimensional (3D) graphics to be rendered into two-dimensional (2D) image frames. The 2D image frames may be rendered based on object information of each scene in the 3D graphics, and the motion vector 101 may represent changes in the object information between the scenes. The first image frame 102 and the second image frame 103 may be a result of rendering by the rendering engine, and the motion vector 101 may be generated in advance. For example, the motion vector 101 may be generated in advance during the rendering process of the first image frame 102 and the second image frame 103 by the rendering engine. The target image frame 150 may be generated using the motion vector 101, which may be generated in advance, without having to generate the motion vector 101 separately.

The frame generation model 110 may include an image-based model 111. The image-based model 111 may be a neural network-based model. The image-based model 111 may perform an encoding operation and a decoding operation on image information. For example, the image-based model 111 may perform an encoding operation and a decoding operation on image frames, including but not limited to the first image frame 102 and the second image frame 103. The image-based model 111 may include an image-based encoder 1111 and an image-based decoder 1112. The frame generation model 110 may use the motion vector 101 to generate the target image frame 150. For example, the motion vector 101 may be used in encoding operations and/or decoding operations of the image-based encoder 1111 and/or the image-based decoder 1112. For example, the motion vector 101 may be used in data processing of an output of the image-based model 111. For example, data output by the image-based model 111 may be processed based on the motion vector 101. For example, data processing may include data merging and/or data warping.

For example, the frame generation model 110 may perform image-based encoding based on the first image frame 102 at a first time point and the second image frame 103 at a second time point to generate an image-based encoding feature, and the frame generation model 110 may perform image-based decoding based on the image-based encoding feature to generate a first optical flow feature between the first time point and a target time point, and a second optical flow feature between the second time point and said target time point. For example, the image-based encoder 1111 of the frame generation model 110 may perform the image-based encoding based on the first image frame 102 at the first time point and the second image frame 103 at the second time point to generate the image-based encoding feature, and the image-based decoder 1112 of the frame generation model 110 may perform the image-based decoding based on the image-based encoding feature to generate the first optical flow feature between the first time point and a target time point, and the second optical flow feature between the second time point and said target time point. The frame generation model 110 may use the motion vector 101 when performing image-based decoding. For example, the motion vector 101 may be used as an input to the image-based decoder 1112.

The frame generation model 110 may use the first optical flow feature, the second optical flow feature, and the motion vector 101 corresponding to the motion between the first image frame 102 and the second image frame 103 to generate the target image frame 150 at a target time point. The frame generation model 110 may use the first optical flow feature, the second optical flow feature, and the motion vector 101 to warp the first image frame 102 and the second image frame 103. The frame generation model 110 may merge a result of the warping with residual information using a weight mask to generate the target image frame 150. The weight mask and residual information will be described in more detail later.

FIG. 1A may correspond to an example where the motion vector 101 is used, and FIG. 1B may correspond to an example where an encoding result and/or a decoding result of the motion vector 101 are used.

Referring to FIG. 1B, the frame generation model 120 may include an image-based model 121 and a motion-based model 122. The image-based model 121 and the motion-based model 122 may each be a neural network-based model.

The image-based model 121 may include an image-based encoder 1211 and an image-based decoder 1212. The motion-based model 122 may include a motion-based encoder 1221 and a motion-based decoder 1222. The motion-based model 122 may perform an encoding operation and a decoding operation on motion information. For example, the motion-based model 122 may perform an encoding operation and a decoding operation on the motion vector 101.

The frame generation model 120 may use the motion vector 101 to generate a target image frame 160. For example, an encoding result and/or decoding result of the motion vector 101 may be used in an encoding operation and/or decoding operation of the image-based encoder 1111 and/or the image-based decoder 1112. For example, the encoding result and/or decoding result of the motion vector 101 may be used in data processing for an output of the image-based model 121.

For example, the frame generation model 120 may perform motion-based encoding based on the motion vector 101 to generate a motion-based encoding feature, and the frame generation model 120 may perform motion-based decoding based on the motion-based encoding feature to generate a first motion feature between a first time point and a target time point, and a second motion feature between a second time point and a target time point. For example, the motion-based encoder 1221 of the frame generation model 120 may perform the motion-based encoding based on the motion vector 101 to generate the motion-based encoding feature, and the motion-based decoder 1222 of the frame generation model 120 may perform the motion-based decoding based on the motion-based encoding feature to generate the first motion feature between the first time point and the target time point, and the second motion feature between the second time point and the target time point.

For example, the frame generation model 120 may scale the motion vector 101 based on the target time point to generate a first approximated motion vector corresponding to motion between the first time point and the target time point and a second approximated motion vector corresponding to motion between the second time point and the target time point, and perform motion-based encoding using the first image frame 102, the second image frame 103, the first approximated motion vector, and the second approximated motion vector. For example, the motion-based encoder 1221 of the frame generation model 120 may scale the motion vector 101 based on the target time point to generate the first approximated motion vector and the second approximated motion vector, and perform the motion-based encoding using the first image frame 102, the second image frame 103, the first approximated motion vector, and the second approximated motion vector.

For example, the frame generation model 120 may perform image-based decoding using an image-based encoding feature, the first motion feature, and the second motion feature. For example, the image-based decoder 1212 of the frame generation model 120 may perform image-based decoding using the image-based encoding feature, the first motion feature, and the second motion feature. The frame generation model 120 may use a first optical flow feature, a second optical flow feature, the first motion feature, and the second motion feature to generate the target image frame 160.

According to an embodiment, motion-based encoding and image-based encoding may each include a plurality of encoding levels. The plurality of encoding levels may correspond to, for example, pyramid encoding. For example, at each encoding level, encoding features may be generated. For example, the sizes of the encoding features at each encoding level may be different. As the encoding level increases, the sizes of the encoding features may decrease. A motion-based encoding feature may be generated at each encoding level of the motion-based encoding, and an image-based encoding feature may be generated at each encoding level of the image-based encoding. The motion-based decoding and image-based decoding may each include a plurality of decoding levels. The plurality of decoding levels may correspond to, for example, pyramid decoding.

The motion vector and optical flow may be distinguished from each other. The motion vector may have an accurate value unrelated to the scale for geometric motion. Optical flow may have a lower accuracy than the motion vector due to a receptive field and ambiguity, but may represent a motion in which a light source effect, reflection, refraction, and the like are reflected. According to one or more embodiments, the motion vector and optical flow may be used complementarily, and accurate motion estimation may be achieved regardless of the type of object. As the motion vector is used, an estimation result that is robust to large motion may be obtained.

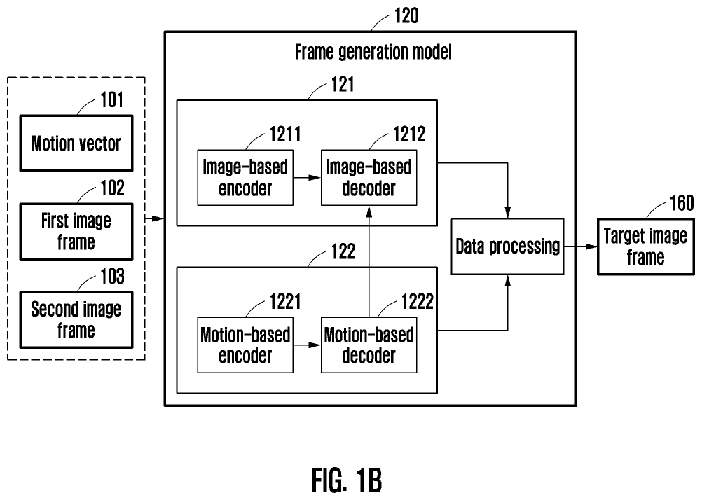

FIG. 2 is a diagram illustrating an example of a first time point, a second time point, and a target time point according to an embodiment. Referring to FIG. 2, a target time point 230 may be an arbitrary time point between a first time point 210 and a second time point 220. For example, the first time point 210 may be denoted as “0”, the second time point 220 may be denoted as “1”, and the target time point 230 may be denoted as t. In this case, 0<t<1 may be established. For example, t=0.5, but is not limited thereto. For example, according to one or more embodiments, one target image frame corresponding to t=0.5 may be generated, or nine target image frames corresponding to t=0.1 to t=0.9 may be generated, but are not limited thereto.

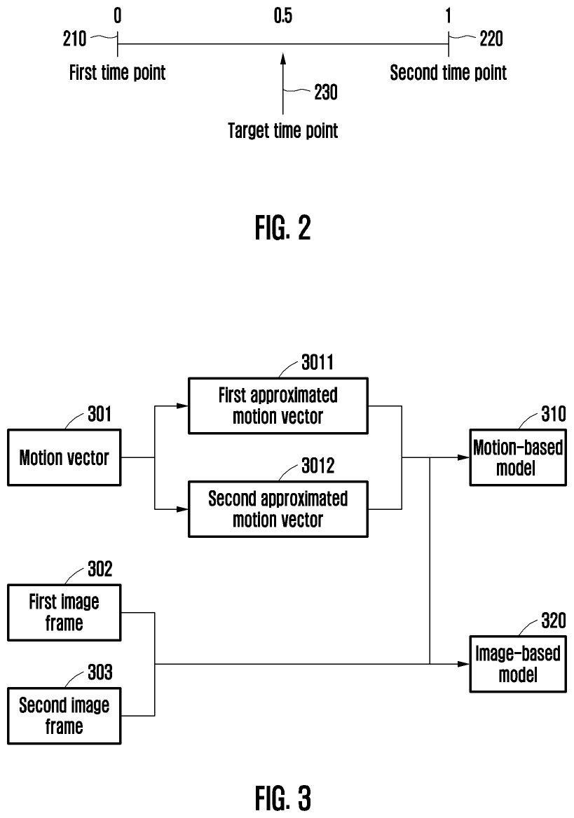

FIG. 3 is a diagram illustrating an example of input data for each of a motion-based model and an image-based model according to an embodiment. Referring to FIG. 3, a first approximated motion vector 3011 corresponding to motion between a first time point and a target time point and a second approximated motion vector 3012 corresponding to motion between a second time point and a target time point may be generated by scaling a motion vector 301 based on the target time point.

For example, the first approximated motion vector 3011 and the second approximated motion vector 3012 may be generated based on Equation 1 and Equation 2 below.

$${f}_{t \to 0} = {tf}_{1 \to 0} \qquad [ Equation 1 ]$$

$${f}_{t \to 1} = - ( 1 - t ) {f}_{1 \to 0} \qquad [ Equation 2 ]$$

In Equation 1 and Equation 2, f_{1→0} denotes the motion vector 301, f_{t→0} denotes the first approximated motion vector 3011, f_{t→1} denotes the second approximated motion vector 3012, “0” denotes the first time point, “1” denotes the second time point, and t denotes the target time point.

According to an embodiment, the first approximated motion vector 3011, the second approximated motion vector 3012, a first image frame 302, and a second image frame 303 may be input to a motion-based model 310. The motion-based model 310 may perform motion-based encoding using the first image frame 302, the second image frame 303, the first approximated motion vector 3011, and the second approximated motion vector 3012. According to an embodiment, the first image frame 302 and the second image frame 303 may be input to an image-based model 320. The image-based model 320 may perform image-based encoding using the first image frame 302 and the second image frame 303.

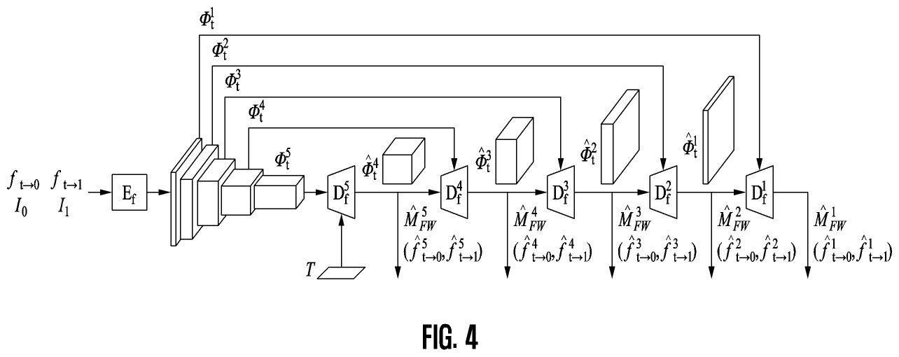

FIG. 4 is a diagram illustrating an example of a configuration of a motion-based model according to an embodiment. Referring to FIG. 4, a motion-based encoding model E_{f} may perform motion-based encoding based on a first image frame I₀ at a first time point, a second image frame I₁ at a second time point, a first approximated motion vector f_{t→0}, and a second approximated motion vector f_{t→1} to generate a motion-based encoding feature

$${ϕ}_{t}^{k}$$

The motion-based encoding may include a plurality of encoding levels. For example, the motion-based encoding model E_{f} may perform pyramid encoding of the plurality of encoding levels. The motion-based encoding may be expressed by Equation 3 below.

$${ϕ}_{t}^{k} = {E}_{f} ( {I}_{0} , {I}_{1} , {f}_{t \to 0} , {f}_{t \to 1} ) , \{ k ∈ \{ 1 , 2 , 3 , 4 , 5 \} \} \qquad [ Equation 3 ]$$

Here, k denotes an encoding level. According to an embodiment, examples of a case where k=1, 2, 3, 4, and 5 are described, but the disclosure is not limited thereto. Motion-based decoding models

$${D}_{f}^{k}$$

may perform motion-based decoding based on the motion-based encoding feature

$${ϕ}_{t}^{k}$$

to generate a motion-based decoding feature

$${\hat{ϕ}}_{t}^{k} ,$$

a first motion feature

$${\hat{f}}_{t \to 0}^{k} ,$$

and a second motion feature.

$$\text{?} .$$

$$\text{?} \text{indicates text missing or illegible when filed}$$

The motion-based decoding may include a plurality of decoding levels. At a k-th decoding level, the motion-based decoding models

$${D}_{f}^{k}$$

may generate a (k−1)-th motion-based decoding feature

$$\text{?} ,$$

$$\text{?} \text{indicates text missing or illegible when filed}$$

the first motion feature

$$\text{?}$$

$$\text{?} \text{indicates text missing or illegible when filed}$$

at the k-th decoding level, and the second motion feature

$$\text{?}$$

$$\text{?} \text{indicates text missing or illegible when filed}$$

at the k-th decoding level based on a k-th motion-based encoding feature

$$\text{?}$$

$$\text{?} \text{indicates text missing or illegible when filed}$$

generated at a k-th encoding level and a k-th motion-based decoding feature

$$\text{?}$$

$$\text{?} \text{indicates text missing or illegible when filed}$$

generated at a (k+1)-th decoding level. The k-th deconding level may correspond to a current decoding level, the (k+1)-th decoding level may correspond to a previous decoding level, and the (k−1)-th decoding level may correspond to a subsequent decoding level.

The motion-based decoding for each level may be expressed by Equations 4 through 6 below.

$$[ {\hat{f}}_{t \to 0}^{5} , {\hat{f}}_{t \to 1}^{5} , {\hat{M}}_{FW}^{5} , {\hat{ϕ}}_{t}^{4} ] = {D}_{f}^{5} ( [ {ϕ}_{t}^{5} , T ] ) \qquad [ Equation 4 ]$$

Equation 4 may represent a decoding operation at a first decoding level of the motion-based decoding. In an example where k=1, 2, 3, 4, and 5, k may be “5” at the first decoding level. Equation 4 may represent a case where k=5. In Equation 4, T denotes a target time point, and

$${\hat{M}}_{FW}^{k}$$

denotes a weight mask. In accordance with the motion-based decoding, the weight mask

$${\hat{M}}_{FW}^{k}$$

may be generated at each decoding level. The weight mask

$${\hat{M}}_{FW}^{k}$$

may be used for weighted merging of a motion feature and an optical flow feature.

$$[ {\hat{f}}_{t \to 0}^{k} , {\hat{f}}_{t \to 1}^{k} , {\hat{M}}_{FW}^{k} , {\hat{ϕ}}_{t}^{k - 1} ] = {D}_{f}^{k} ( [ {\hat{ϕ}}_{t}^{k} , {ϕ}_{t}^{k} ] ) \qquad [ Equation 5 ]$$

$$[ {\hat{f}}_{t \to 0}^{1} , {\hat{f}}_{t \to 1}^{1} , {\hat{M}}_{FW}^{1} ] = {D}_{f}^{1} ( [ {\hat{ϕ}}_{t}^{1} , {ϕ}_{1}^{k} ] ) \qquad [ Equation 6 ]$$

Equation 6 may represent a decoding operation at a last decoding level of the motion-based decoding. Equation 5 may represent a decoding operation at a remaining decoding level of the motion-based decoding. Here, the remaining decoding level of the motion-based decoding may refer to one or more decoding levels prior to the last decoding level of the motion-based decoding. For example, the remaining decoding level may be referred to as an intermediate decoding level. In an example where k=1, 2, 3, 4, and 5, k may be “1” at the last decoding level. Equation 6 may represent a case where k=1, and Equation 5 may represent a case where k=2, 3, and 4.

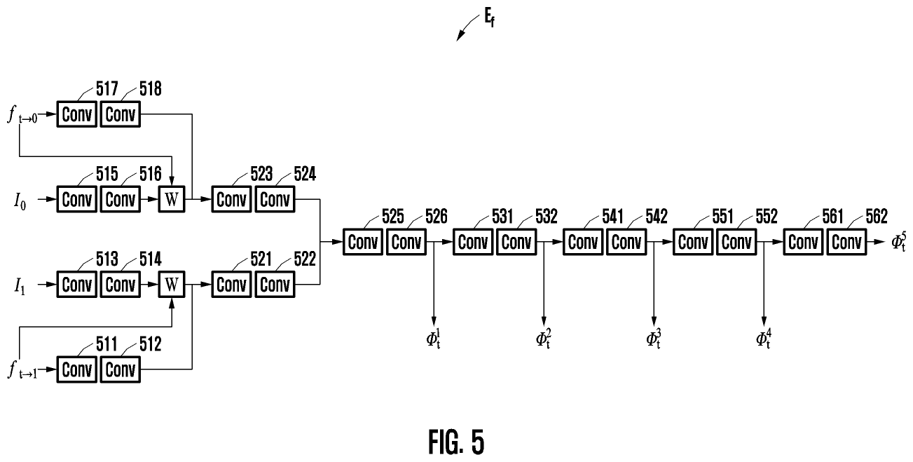

FIG. 5 is a diagram illustrating an example of a configuration of a motion-based encoding model according to an embodiment. Referring to FIG. 5, the motion-based encoding model E_{f} may perform motion-based encoding using convolutional layers 511 to 518, 521 to 526, 531, 532, 541, 542, 551, 552, 561, and 562 to generate a motion-based encoding feature

$$\text{?}$$

$$\text{?} \text{indicates text missing or illegible when filed}$$

based on the first image frame I₀, the second image frame I₁, the first approximated motion vector f_{t→0}, and the second approximated motion vector f_{t→1}. “W” may represent a warping operation (e.g., backward warping). The first image frame I₀ and the second image frame I₁ may be warped based on the first approximated motion vector f_{t→0} and the second approximated motion vector f_{t→1}. Although FIG. 5 illustrates convolutional layers 511 to 518, 521 to 526, 531, 532, 541, 542, 551, 552, 561, and 562, the disclosure is not limited thereto, and as such, according to another embodiment, the number of convolutional layers may be different.

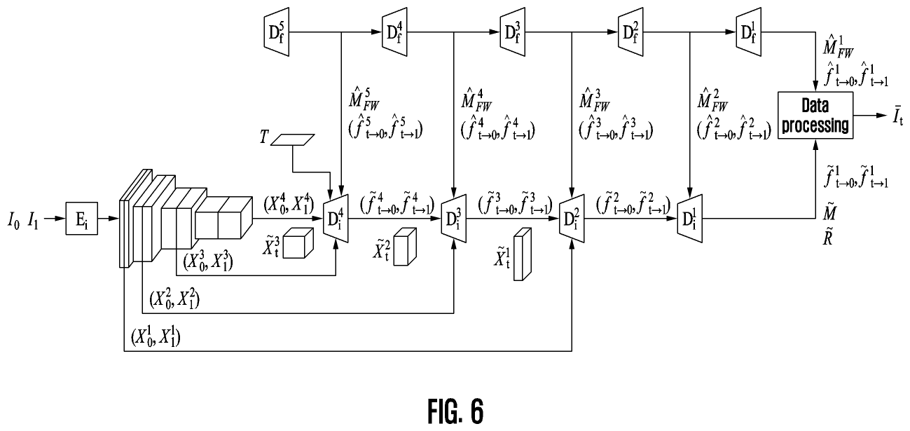

FIG. 6 is a diagram illustrating an example of a configuration of an image-based model according to an embodiment. Referring to FIG. 6, an image-based encoding model Eᵢ may perform image-based encoding based on the first image frame I₀ at a first time point and the second image frame I₁ at a second time point to generate image-based encoding features

$${x}_{0}^{k} and {x}_{1}^{k} .$$

The image-based encoding feature

$${x}_{0}^{k}$$

may be generated by the image-based encoding based on the first image frame I₀, and the image-based encoding feature

$$\text{?}$$

$$\text{?} \text{indicates text missing or illegible when filed}$$

may be generated by the image-based encoding based on the second image frame I₁. The image-based encoding may include a plurality of encoding levels.

The number of levels of motion-based encoding and motion-based decoding may be greater than the number of levels of image-based encoding and image-based decoding. For example, the number of levels of motion-based encoding and motion-based decoding may be one more than the number of levels of image-based encoding and image-based decoding, but is not limited thereto. For example, the number of levels of motion-based encoding and motion-based decoding may be “5”, and the number of levels of image-based encoding and image-based decoding may be “4”, but is not limited thereto. According to an embodiment, examples of a case where k=1, 2, 3, and 4 are described, but the disclosure is not limited thereto.

Image-based decoding models

$$\text{?}$$

$$\text{?} \text{indicates text missing or illegible when filed}$$

may perform image-based decoding based on the image-based encoding features

$${x}_{0}^{k} and {x}_{1}^{k} ,$$

the first motion feature

$$\text{?} ,$$

$$\text{?} \text{indicates text missing or illegible when filed}$$

and the second motion feature

$$\text{?}$$

$$\text{?} \text{indicates text missing or illegible when filed}$$

to generate an image-based decoding feature

$$\text{?} ,$$

$$\text{?} \text{indicates text missing or illegible when filed}$$

a first optical flow feature

$$\text{?}$$

$$\text{?} \text{indicates text missing or illegible when filed}$$

between a first time point and a target time point, and a second optical flow feature

$$\text{?}$$

$$\text{?} \text{indicates text missing or illegible when filed}$$

between a second time point and the target time point. The image-based decoding may include a plurality of decoding levels. At a k-th decoding level, the image-based decoding models

$$\text{?}$$

$$\text{?} \text{indicates text missing or illegible when filed}$$

may generate a (k−1)-th image-based decoding feature

$${\tilde{x}}_{t}^{k - 1} ,$$

the first optical flow feature

$$\text{?}$$

$$\text{?} \text{indicates text missing or illegible when filed}$$

at a k-th decoding level, and the second optical flow feature

$${\hat{f}}_{t \to 1}^{k}$$

at the k-th decoding level, based on the k-the image-based encoding features

$${x}_{0}^{k} and {x}_{1}^{k}$$

generated at a k-th encoding level, the k-th image-based decoding feature

$$\text{?}$$

$$\text{?} \text{indicates text missing or illegible when filed}$$

generated at a (k+1)-th decoding level, the first motion feature

$${\hat{f}}_{t \to 0}^{k + 1}$$

at the (k+1)-th decoding level, and the second motion feature

$$\tilde{f} \text{?}$$

$$\text{?} \text{indicates text missing or illegible when filed}$$

at the (k+1)-th decoding level. The k-th decoding level may correspond to a current decoding level, the (k+1)-th decoding level may correspond to a previous decoding level, and the (k−1)-th decoding level may correspond to a subsequent decoding level.

The image-based decoding for each level may be expressed by Equations 7 through 9 below.

$$[ {\tilde{f}}_{t \to 0}^{4} , {\tilde{f}}_{t \to 1}^{4} , {\tilde{X}}_{t}^{3} ] = {D}_{i}^{4} ( {X}_{0}^{4} , {X}_{1}^{4} , {\tilde{f}}_{t \to 0}^{5} , {\tilde{f}}_{t \to 1}^{5} , T ) \qquad [ Eqaution 7 ]$$

Equation 7 may represent a decoding operation at a first decoding level of the image-based decoding. In an example where k=1, 2, 3, and 4, k may be “4” at the first decoding level. Equation 7 may represent a case where k=4. In Equation 7, T denotes a target time point.

$$[ {\tilde{f}}_{t \to 0}^{k} , {\tilde{f}}_{t \to 1}^{k} , {\tilde{X}}_{t}^{k − 1} ] = {D}_{i}^{k} ( {\tilde{X}}_{t}^{k} , {X}_{0}^{k} , {X}_{1}^{k} , {\tilde{f}}_{t \to 0}^{k + 1} , {\tilde{f}}_{t \to 1}^{k + 1} ) \qquad [ Eqaution 8 ]$$

$$[ {\tilde{f}}_{t \to 0}^{1} , {\tilde{f}}_{t \to 1}^{1} , \tilde{M} , \tilde{R} ] = {D}_{i}^{1} ( {\tilde{X}}_{i}^{1} , {X}_{0}^{1} , {X}_{1}^{1} , {\tilde{f}}_{t \to 0}^{2} , {\tilde{f}}_{t \to 1}^{2} ) \qquad [ Eqaution 9 ]$$

Equation 9 may represent a decoding operation at a last decoding level of the image-based decoding. Equation 8 may represent a decoding operation at a remaining decoding level of the image-based decoding. Here, the remaining decoding level of the image-based decoding may refer to one or more decoding levels prior to the last decoding level of the image-based decoding. For example, the remaining decoding level may be referred to as an intermediate decoding level. In an example where k=1, 2, 3, and 4, k may be “1” at the last decoding level. Equation 9 may represent a case where k=1, and Equation 8 may represent a case where k=2 and 3.

In Equations 7, 8, and 9,

$${\tilde{f}}_{t \to 0}^{k}$$

denotes a first merged flow and

$${\tilde{f}}_{t \to 1}^{k}$$

denotes a second merged flow. A motion feature and an optical flow feature from corresponding decoding levels may be merged based on a weight mask. The first motion feature and the first optical flow feature may be merged to generate the first merged flow, and the second motion feature and the second optical flow feature may be merged to generate the second merged flow.

For example, at a (k+1)-th decoding level of the motion-based decoding, a (k+1)-th weight mask may be generated. The first motion feature generated at the (k+1)-th decoding level of the motion-based decoding and the first optical flow feature generated at a (k+1)-th decoding level of the image-based decoding may be merged to generate the first merged flow at the (k+1)-th decoding level, based on the (k+1)-th weight mask. The (k+1)-th merged flow may be used at the k-th decoding level of the image-based decoding. For example, the (k−1)-th image-based decoding feature, the first optical flow feature at the k-th decoding level, and the second optical flow feature at the k-th decoding level may be generated, based on the k-th image-based encoding feature, the k-th image-based decoding feature, and the (k+1)-th merged flow.

Each merged flow of each encoding level may be generated based on Equation 10 and Equation 11 below.

$$\begin{matrix}{\tilde{f}}_{t \to 0}^{5} & = ℱ ( 0 , {\hat{f}}_{t \to 0}^{5} , {\hat{M}}_{FW}^{5} ) , {\tilde{f}}_{t \to 1}^{5} = ℱ ( 0 , {\hat{f}}_{t \to 1}^{5} , {\hat{M}}_{FW}^{5} )\end{matrix} \qquad [ Equation 10 ]$$

$$\begin{matrix}{\tilde{f}}_{t \to 0}^{k} & = ℱ ( {\tilde{f}}_{t \to 0}^{k} , {\hat{f}}_{t \to 0}^{k} , {\hat{M}}_{FW}^{k} ) , {\tilde{f}}_{t \to 1}^{k} = ℱ ( {\tilde{f}}_{t \to 1}^{k} , {\hat{f}}_{t \to 1}^{k} , {\hat{M}}_{FW}^{k} )\end{matrix} \qquad [ Equation 11 ]$$

According to an embodiment, when k=5, the first merged flow

$$f \text{?}$$

$$\text{?} \text{indicates text missing or illegible when filed}$$

and the second merged flow

$$f \text{?}$$

$$\text{?} \text{indicates text missing or illegible when filed}$$

may be generated based on Equation 10. According to an embodiment, when k=1, 2, 3, and 4, the first merged flow

$$f \text{?}$$

$$\text{?} \text{indicates text missing or illegible when filed}$$

and the second merged flow

$$f \text{?}$$

$$\text{?} \text{indicates text missing or illegible when filed}$$

may be generated based on Equation 11.

In Equation 9, \tilde{M} denotes a merging mask and \tilde{R} denotes an image residual. For example, the merging mask \tilde{M} may be a 1-channel merging mask with a range of “0” to “1” derived from a sigmoid layer. The image residual \tilde{R} may be a 3-channel image residual.

A target image frame Īₜ at a target time point may be generated based on the motion vector (e.g., the first motion feature

$$f \text{?}$$

$$\text{?} \text{indicates text missing or illegible when filed}$$

and the second motion feature

$$f \text{?}$$

$$\text{?} \text{indicates text missing or illegible when filed}$$

generated from the motion vector), the first optical flow feature

$${\hat{f}}_{t \to 0}^{k} ,$$

and the second optical flow feature

$${\tilde{f}}_{t \to 1}^{k} .$$

For example, the merged flows

$$f \text{?} and f \text{?}$$

$$\text{?} \text{indicates text missing or illegible when filed}$$

may be determined based on the first motion feature

$${\hat{f}}_{t \to 0}^{k} ,$$

the second motion feature

$${\hat{f}}_{t \to 1}^{k} ,$$

the first optical flow feature

$${\hat{f}}_{t \to 0}^{k} ,$$

and the second optical flow feature

$${\hat{f}}_{t \to 1}^{k} .$$

The target image frame Īₜ may be generated by warping the first image frame I₀ and the second image frame I₁ using the merged flows

$${\hat{f}}_{t \to 0}^{k} and {\hat{f}}_{t \to 1}^{k} ,$$

and merging a result of the warping with residual information using the merging mask \tilde{M}. For example, the target image frame Īₜ may be generated based on Equation 12 below.

$${\overline{I}}_{t} = M \cdot W ( {I}_{0} , {\overline{f}}_{t \to 1} ) + ( 1 - M ) \cdot W ( {I}_{1} , {\overline{f}}_{t \to 1} \} + R \qquad [ Equation 12 ]$$

In Equation 12, W may represent a warping operation, M may correspond to the merging mask \tilde{M}, and R may correspond to the image residual R̅. The residual information may correspond to the image residual R̅. f̅_{t→0} and f̅_{t→1} may correspond to a case where k=1 in Equation 12.

In Equation 10 and Equation 11, [symbol] may represent a merge operation. The merge operation [symbol] may be defined based on Equation 13 below.

$$ℱ ( {\overline{f}}^{k} , {\hat{f}}^{k} , {\hat{M}}_{FW}^{k} ) = ( 1 - {\hat{M}}_{FW}^{k} ) \cdot {\overline{f}}^{k} + {\hat{M}}_{FW}^{k} \cdot {\hat{f}}^{k} \qquad [ Equation 13 ]$$

In Equation 13, \tilde{f}^{k} may denote

$${\overline{f}}_{t \to 0}^{k} or {\overline{f}}_{t \to 1}^{k} ,$$

and \hat{f}^{k} may denote

$${\hat{f}}_{t \to 0}^{k} or {\hat{f}}_{t \to 1}^{k} .$$

To train the frame generation model according to an embodiment, a loss function may be used as shown in Equation 14 below.

$$ℒ = {λ}_{char} {ℒ}_{char} + {λ}_{cen} {ℒ}_{cen} + {λ}_{geo} {ℒ}_{geo} + {λ}_{WFC} {ℒ}_{WFC} \qquad [ Equation 14 ]$$

In Equation 14, [symbol] _{char} denotes the Charbonnier loss. The Charbonnier loss may be expressed by [symbol] _{char} and [symbol] _{char}(x)=(x²ϵ²)^{α}. [symbol] _{cen} denotes census loss. The census loss [symbol] _{cen} may be calculated based on the Hamming distance between census-transformed image patches between the target image frame Īₜ and ground truth (GT). [symbol] _{geo} denotes geometric loss. The geometric loss [symbol] _{geo} may be expressed by

$${ℒ}_{geo} = {\sum }_{k = 1}^{3} {L}_{cen} ( {\overline{X}}_{t}^{k} , {X}_{t}^{k} ) .$$

The geometric loss [symbol] _{geo} may regularize a reconstructed intermediate feature

$$\overline{{\hat{X}}_{t}^{k}}$$

in a multi-scale feature domain. λ_{char}, λ_{cen}, λ_{geo}, and λ_{WFC} denote a weight of each loss.

[symbol] _{WFC} denotes warped feature consistency (WFC) loss. The WFC loss [symbol] _{WFC} may guide the refinement of intermediate flows and weight masks within a final layer. To constrain the reconstructed intermediate features, the WFC loss [symbol] _{WFC} may employ a feature

$${\overline{X}}_{t}^{1}$$

that is warped through intermediate flows predicted from the GT

$${X}_{t}^{1}$$

and merged through predicted weight masks. The WFC loss [symbol] _{WFC} may be defined based on Equations 15 through 18 shown below.

$${\overline{f}}_{t \to 0}^{1} = ( 1 - {\hat{M}}_{FW}^{1} ) \cdot {\overline{f}}_{t \to 0}^{1} + {\hat{M}}_{FW}^{1} \cdot {\overline{f}}_{t \to 0}^{1} \qquad [ Equation 15 ]$$

$${\overline{f}}_{t \to 1}^{1} = ( 1 - {\hat{M}}_{FW}^{1} ) \cdot {\overline{f}}_{t \to 1}^{1} + {\hat{M}}_{FW}^{1} \cdot {\overline{f}}_{t \to 1}^{1} \qquad [ Equation 16 ]$$

$${\overline{X}}_{t}^{1} = \tilde{M} \cdot W ( {X}_{0}^{k} , {\overline{f}}_{t \to 0}^{1} ) + ( 1 - \tilde{M} ) \cdot W ( {X}_{1}^{1} , {\overline{f}}_{t \to 1}^{1} ) \qquad [ Equation 17 ]$$

$${ℒ}_{WFC} = {‖ {\overline{X}}_{t}^{1} - {X}_{t}^{1} ‖}_{2} \qquad [ Equation 18 ]$$

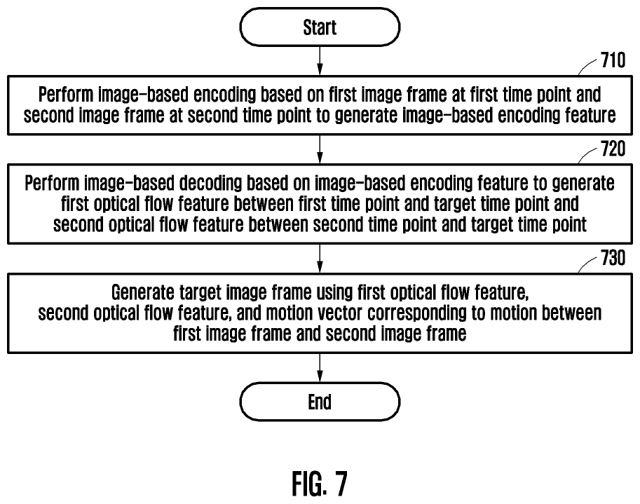

FIG. 7 is a flowchart illustrating an example of a method of generating an image frame according to an embodiment.

Referring to FIG. 7, according to an embodiment, in operation 710, the method may include performing image-based encoding based on a first image frame at a first time point and a second image frame at a second time point to generate an image-based encoding feature For example, an electronic device may perform image-based encoding based on a first image frame at a first time point and a second image frame at a second time point to generate an image-based encoding feature.

According to an embodiment, the method may further include performing motion-based encoding based on the motion vector to generate a motion-based encoding feature, and further performing motion-based decoding based on the motion-based encoding feature to generate a first motion feature between the first time point and the target time point and a second motion feature between the second time point and the target time point. For example, the electronic device may further perform motion-based encoding based on the motion vector to generate a motion-based encoding feature, and further perform motion-based decoding based on the motion-based encoding feature to generate a first motion feature between the first time point and the target time point and a second motion feature between the second time point and the target time point.

The generating of the motion-based encoding feature may include scaling the motion vector based on the target time point to generate a first approximated motion vector corresponding to motion between the first time point and the target time point and to generate a second approximated motion vector corresponding to motion between the second time point and the target time point, and performing motion-based encoding using the first image frame, the second image frame, the first approximated motion vector, and the second approximated motion vector.

According to an embodiment, in operation 720, the method may include performing image-based decoding using the image-based encoding feature, the first motion feature, and the second motion feature. For example, the electronic device may perform the image-based decoding using the image-based encoding feature, the first motion feature, and the second motion feature.

According to an embodiment, in operation 730, the method may include generating a target image frame using the first optical flow feature, the second optical flow feature, the first motion feature, and the second motion feature. For example, the electronic device may generate the target image frame using the first optical flow feature, the second optical flow feature, the first motion feature, and the second motion feature.

The motion-based encoding may include a plurality of encoding levels, including a k-th encoding level, and the motion-based decoding may include a plurality of decoding levels, including a (k+1)-th decoding level and a k-th decoding level. The generating of the first motion feature and the second motion feature may include, at the k-th decoding level, generating a (k−1)-th motion-based decoding feature, the first motion feature at the k-th decoding level, and the second motion feature at the k-th decoding level, based on the k-th motion-based encoding feature generated at the k-th encoding level and the k-th motion-based decoding feature generated at the (k+1)-th decoding level.

The image-based encoding may include a plurality of encoding levels, including a k-th encoding level, and the image-based decoding may include a plurality of decoding levels, including a (k+1)-th decoding level and a k-th decoding level. The generating of the first optical flow feature and the second optical flow feature may include, at the k-th decoding level, generating a (k−1)-th image-based decoding feature, the first optical flow feature at the k-th decoding level, and the second optical flow feature at the k-th decoding level, based on a k-th image-based encoding feature generated at the k-th encoding level, a k-th image-based decoding feature generated at the (k+1)-th decoding level, the first motion feature at the (k+1)-th decoding level, and the second motion feature at the (k+1)-th decoding level.

At the (k+1)-th decoding level of the motion-based decoding, a (k+1)-th weight mask may be generated, and based on the (k+1)-th weight mask, the first motion feature generated at the (k+1)-th decoding level of the motion-based decoding and the first optical flow feature generated at the (k+1)-th decoding level of the image-based decoding may be merged to generate a (k+1)-th merged flow, and the (k+1)-th merged flow may be used at the k-th decoding level of the image-based decoding.

The generating of the (k−1)-th image-based decoding feature, the first optical flow feature at the k-th decoding level, and the second optical flow feature at the k-th decoding level may include generating the (k−1)-th image-based decoding feature, the first optical flow feature at the k-th decoding level, and the second optical flow feature at the k-th decoding level based on the k-th image-based encoding feature, the k-th image-based decoding feature, and the (k+1)-th merged flow.

According to an embodiment, in operation 730, the method may further include warping the first image frame and the second image frame using the first optical flow feature, the second optical flow feature, and the motion vector, and merging a result of the warping with residual information using a merging mask to generate the target image frame.

The first image frame and the second image frame may be a result of rendering by a rendering engine, and the motion vector may be generated in advance during the rendering process of the first image frame and the second image frame by the rendering engine.

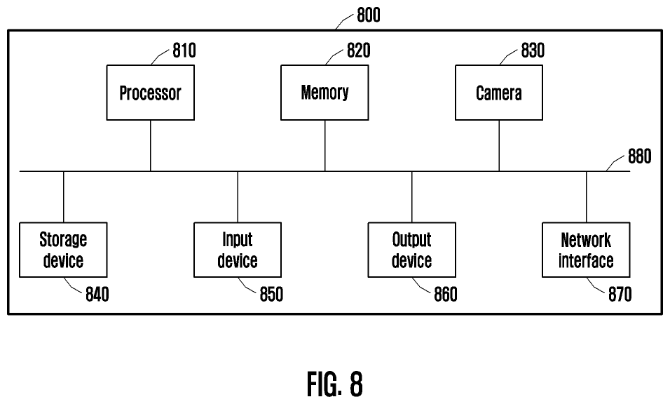

FIG. 8 is a diagram exemplarily illustrating a configuration of an electronic device, according to an embodiment. Referring to FIG. 8, an electronic device 800 may include a processor 810, a memory 820, a camera 830, a storage device 840, an input device 850, an output device 860, and a network interface 870, which may communicate with each other through a communication bus 880. However, the disclosure is not limited thereto, and as such, according to another embodiment, one or more components may be added to, combined with, or omitted from the structure in FIG. 8. For example, the electronic device 800 may be implemented as at least a portion of, for example, a mobile device such as a mobile phone, a smartphone, a personal digital assistant (PDA), a netbook, a tablet computer, a laptop computer, and the like, a wearable device such as a smartwatch, a smart band, smart glasses, and the like, a computing device such as a desktop, a server and the like, a home appliance such as a television (TV), a smart TV, a refrigerator, and the like, a security device such as a door lock and the like, and a vehicle such as an autonomous vehicle, a smart vehicle, and the like.

The processor 810 may execute instructions and functions in the electronic device 800. For example, the processor 810 may process instructions stored in the memory 820 or the storage device 840. The processor 810 may perform the operations described in FIGS. 1A to 7. The memory 820 may include a computer-readable storage medium or a computer-readable storage device. The memory 820 may store instructions, such as software or program code, that are to be executed by the processor 810. Also, the memory 820 may store information or data associated with software and/or applications when the software and/or applications are being executed by the electronic device 800.

The camera 830 may capture a photo and/or a video. The storage device 840 includes a computer-readable storage medium or computer-readable storage device. The storage device 840 may a higher capacity to store more information than the memory 820, and store the information for a long time. For example, the storage device 840 may include, but is not limited to, a magnetic hard disk, an optical disc, a flash memory, a floppy disk, or other types of non-volatile memory known in the art.

The input device 850 may receive an input from a user using various input mechanisms, including but not limited to, a keyboard, a mouse, a touch input, a voice input, and an image input. Accordingly, the input device 850 may include, but is not limited to, a keyboard, a mouse, a touchscreen, a microphone, and any other device that may detect an input from a user and transmit the detected input to the electronic device 800. The output device 860 may provide an output of the electronic device 800 to the user through a visual, auditory, or haptic channel. The output device 860 may include, but is not limited to, a display, a touch screen, a speaker, a vibration generator, or any other device that provides the output to the user. The network interface 870 may communicate with an external device through a wired or wireless network.

One or more embodiments described herein may be implemented using a hardware component, a software component, and/or a combination thereof. For example, blocks referred to as “units”, “modules”, or “˜er” elements may be implemented using a hardware component, a software component, and/or a combination thereof. A processing device may be implemented using one or more general-purpose or special-purpose computers, such as, for example, a processor, a controller and an arithmetic logic unit (ALU), a digital signal processor (DSP), a microcomputer, an FPGA, a programmable logic unit (PLU), a microprocessor, or any other device capable of responding to and executing instructions in a defined manner. The processing device may run an operating system (OS) and one or more software applications that run on the OS. The processing device may also access, store, manipulate, process, and create data in response to execution of the software. For purpose of simplicity, the description of a processing device is singular; however, one of ordinary skill in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or collectively instruct or configure the processing device to operate as desired. Software and/or data may be stored in any type of machine, component, physical or virtual equipment, or computer storage medium or device capable of providing instructions or data to or being interpreted by the processing device. The software may also be distributed over network-coupled computer systems so that the software is stored and executed in a distributed fashion. The software and data may be stored in a non-transitory computer-readable recording medium.

The methods according to one or more embodiments may be recorded in non-transitory computer-readable media including program instructions to implement various operations of the examples. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter.

The above-described hardware devices may be configured to act as one or more software modules in order to perform the operations of the above-described embodiments, or vice versa.

Although the embodiments have been described with reference to the limited drawings, one of ordinary skill in the art may apply various technical modifications and variations based thereon. For example, suitable results may be achieved if the described techniques are performed in a different order, and/or if components in a described system, architecture, device, or circuit are combined in a different manner, and/or replaced or supplemented by other components or their equivalents. Therefore, other implementations, other embodiments, and equivalents to the claims are also within the scope of the following claims.

What is claimed is:

1. A method comprising:
performing a first encoding operation based on a first image frame at a first time point and a second image frame at a second time point to generate a first encoding feature;
performing a first decoding operation based on the first encoding feature to generate a first optical flow feature between the first time point and a third time point and a second optical flow feature between the second time point and the third time point; and
generating a third image frame at the third time point based on the first optical flow feature, the second optical flow feature, and a motion vector corresponding to motion between the first image frame and the second image frame.

2. The method of claim 1, further comprising:
performing a second encoding operation based on the motion vector to generate a second encoding feature; and
performing a second decoding operation based on the second encoding feature to generate a first motion feature between the first time point and the third time point and a second motion feature between the second time point and the third time point.

3. The method of claim 2, wherein the generating of the second encoding feature comprises:
scaling the motion vector based on the third time point to generate a first approximated motion vector corresponding to motion between the first time point and the third time point and a second approximated motion vector corresponding to motion between the second time point and the third time point; and
performing the second encoding operation using the first image frame, the second image frame, the first approximated motion vector, and the second approximated motion vector.

4. The method of claim 2, wherein the generating of the first optical flow feature and the second optical flow feature comprises performing the first decoding operation based on the first encoding feature, the first motion feature, and the second motion feature.

5. The method of claim 2, wherein the third image frame is generated based on the first optical flow feature, the second optical flow feature, the first motion feature, and the second motion feature.

6. The method of claim 2, wherein the second encoding operation comprises a plurality of second encoding levels including a k-th second encoding level, and the second decoding operation comprises a plurality of second decoding levels including a (k+1)-th second decoding level and a k-th second decoding level, and
wherein the generating of the first motion feature and the second motion feature comprises generating, at the k-th second decoding level, a (k−1)-th second decoding feature, the first motion feature at the k-th second decoding level, and the second motion feature at the k-th second decoding level, based on a k-th second encoding feature generated at the k-th second encoding level and a k-th second decoding feature generated at the (k+1)-th decoding level.

7. The method of claim 6, wherein the first encoding operation comprises a plurality of first encoding levels including a k-th first encoding level, and the first decoding operation comprises a plurality of first decoding levels including a (k+1)-th first decoding level and a k-th first decoding level, and
wherein the generating of the first optical flow feature and the second optical flow feature comprises generating, at the k-th first decoding level, a (k−1)-th first decoding feature, the first optical flow feature at the k-th first decoding level, and the second optical flow feature at the k-th first decoding level, based on a k-th first encoding feature generated at the k-th first encoding level, a k-th first decoding feature generated at the (k+1)-th first decoding level, the first motion feature at the (k+1)-th first decoding level, and the second motion feature at the (k+1)-th first decoding level.

8. The method of claim 7, wherein a (k+1)-th weight mask is generated at the (k+1)-th second decoding level of the second decoding operation,
wherein, based on the (k+1)-th weight mask, the first motion feature generated at the (k+1)-th second decoding level of the second decoding and the first optical flow feature generated at the (k+1)-th first decoding level of the first decoding operation are merged to generate a (k+1)-th merged flow, and
wherein the (k+1)-th merged flow is used at the k-th first decoding level of the first decoding operation.

9. The method of claim 8, wherein the generating of the (k−1)-th first decoding feature, the first optical flow feature at the k-th first decoding level, and the second optical flow feature at the k-th first decoding level comprises generating the (k−1)-th first decoding feature, the first optical flow feature at the k-th first decoding level, and the second optical flow feature at the k-th first decoding level, based on the k-th first encoding feature, the k-th first decoding feature, and the (k+1)-th merged flow.

10. The method of claim 1, wherein the generating of the third image frame comprises:
warping the first image frame and the second image frame based on the first optical flow feature, the second optical flow feature, and the motion vector; and
merging a result of the warping with residual information based on a merging mask to generate the third image frame.

11. The method of claim 1, wherein the first image frame and the second image frame are a result of a rendering by a rendering engine, and the motion vector is generated in advance during the rendering of the first image frame and the second image frame by the rendering engine.

12. A non-transitory computer-readable storage medium storing instructions that, when executed by a processor, cause the processor to perform the method of claim 1.

13. An electronic device comprising:
one or more processors; and
a memory configured to store instructions,
wherein the instructions, when executed by the one or more processors, cause the electronic device to:
perform a first encoding operation based on a first image frame at a first time point and a second image frame at a second time point to generate a first encoding feature;
perform a first decoding operation based on the first encoding feature to generate a first optical flow feature between the first time point and a third time point and a second optical flow feature between the second time point and the third time point; and
generate a third image frame at the third time point based on the first optical flow feature, the second optical flow feature, and a motion vector corresponding to motion between the first image frame and the second image frame.

14. The electronic device of claim 13, wherein the instructions, when executed by the one or more processors, cause the electronic device to:
perform a second encoding operation based on the motion vector to generate a second encoding feature; and
perform a second decoding operation based on the second encoding feature to generate a first motion feature between the first time point and the third time point and a second motion feature between the second time point and the third time point.

15. The electronic device of claim 14, wherein for the generating of the second encoding feature, the instructions, when executed by the one or more processors, cause the electronic device to:
scale the motion vector based on the third time point to generate a first approximated motion vector corresponding to motion between the first time point and the third time point and a second approximated motion vector corresponding to motion between the second time point and the third time point; and
perform the second encoding operation using the first image frame, the second image frame, the first approximated motion vector, and the second approximated motion vector.

16. The electronic device of claim 14, wherein the instructions, when executed by the one or more processors, further cause the electronic device to: perform the first decoding operation based on the first encoding feature, the first motion feature, and the second motion feature.

17. The electronic device of claim 14, the third image frame is generated based on the first optical flow feature, the second optical flow feature, the first motion feature, and the second motion feature.

18. The electronic device of claim 13, wherein the instructions, when executed by the one or more processors, further cause the electronic device to:
warp the first image frame and the second image frame based on the first optical flow feature, the second optical flow feature, and the motion vector; and
merge a result of the warping with residual information based on a merging mask to generate the third image frame.

19. The electronic device of claim 13, wherein the first image frame and the second image frame are a result of a rendering by a rendering engine, and the motion vector is generated in advanced during the rendering of the first image frame and the second image frame by the rendering engine.

20. An electronic device comprising:
a memory configured to store instructions, and
one or more processors configured to execute the instructions, the instructions when executed by the one or more processors, cause the electronic device to:
perform a first encoding operation based on a first image frame at a first time point and a second image frame at a second time point to generate a first encoding feature;
perform a first decoding operation based on the first encoding feature to generate a first optical flow feature between the first time point and a third time point and a second optical flow feature between the second time point and the third time point;
perform a second encoding operation based on a motion vector based on the first image and the second image to generate a second encoding feature;
perform a second decoding operation based on the second encoding feature to generate a first motion feature between the first time point and the third time point and a second motion feature between the second time point and the third time point; and
generate a third image frame at the third time point based on the first optical flow feature, the second optical flow feature, the first motion feature and the second motion feature.
